(19) United States
(12) Patent Application Publication
(10) Pub. No.: US 2025/0310462 A1
(43) Pub. Date: Oct. 2, 2025

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Mitsuhiro FUKUSHIMA, Kanagawa (JP)

(73) Assignee: FUJIFILM Business Innovation Corp., Tokyo (JP)

(21) Appl. No.: 18/800,394

(22) Filed: Aug. 12, 2024

(30) Foreign Application Priority Data
Mar. 27, 2024 (JP) 2024-052317

(51) Int. Cl. H04N 1/387

(52) U.S. Cl. CPC H04N 1/3875

(57) ABSTRACT

An information processing system includes at least one processor configured to accept page information, including a size of designated paper, and print character data, and if a print position of the print character data is outside an area of the size of the designated paper, automatically enlarge the print area in the print character data such that the print position is included.

### CROSS-REFERENCE TO RELATED APPLICATIONS

This application is based on and claims priority under 35 USC 119 from Japanese Patent Application No. 2024-052317 filed Mar. 27, 2024.

### BACKGROUND

### (i) Technical Field

The present disclosure relates to an information processing system, an information processing method, and a non-transitory computer readable medium.

### (ii) Related Art

Japanese Unexamined Patent Application Publication No. 2009-042836 and Japanese Unexamined Patent Application Publication No. 2012-084176 disclose image processing apparatuses that output by clipping a print area according to a preset drawing mode when a drawing area size defined in print data and an output paper size are mismatched. Japanese Unexamined Patent Application Publication No. 7-156462 discloses a print data creation apparatus that determines an output paper size according to the content of inputted print data and a mode designation of an automatic paper selection mode or an automatic scale selection mode.

### SUMMARY

Aspects of non-limiting embodiments of the present disclosure relate to outputting print characters without missing print characters, even when the print character data is outside the area of a designated paper size.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing system including at least one processor configured to accept page information, including a size of designated paper, and print character data, and if a print position of the print character data is outside an area of the size of the designated paper, automatically enlarge the print area in the print character data such that the print position is included.

### BRIEF DESCRIPTION OF THE DRAWINGS

Exemplary embodiments of the present disclosure will be described in detail based on the following figures, wherein:

FIG. 1 is a diagram illustrating a system configuration of an information processing system according to an exemplary embodiment of the technology of the present disclosure;

FIG. 2 is a block diagram illustrating a hardware configuration of a PC according to an exemplary embodiment;

FIG. 3 is a block diagram illustrating a functional configuration of the PC in FIG. 2;

FIG. 4 is a plan view of roll paper in overlay printing according to an exemplary embodiment;

FIG. 5 is a block diagram illustrating a hardware configuration of a printer according to an exemplary embodiment;

FIG. 6 is a block diagram illustrating a functional configuration of a control device of the printer in FIG. 5;

FIG. 7 is a flowchart illustrating an example of a process in a printer according to an exemplary embodiment;

FIG. 8 is a plan view of roll paper in printing with no print area enlargement according to an exemplary embodiment;

FIG. 9 is a plan view of roll paper in imposition printing with no print area enlargement according to an exemplary embodiment;

FIG. 10 is a plan view of roll paper in imposition printing with print area enlargement according to an exemplary embodiment;

FIG. 11 is a plan view of roll paper in printing with print area enlargement that is not overlay printing according to an exemplary embodiment; and

FIG. 12 is a plan view of roll paper in overlay printing with print area enlargement according to an exemplary embodiment.

### DETAILED DESCRIPTION

Hereinafter, an information processing system and an information processing program according to an exemplary embodiment of the present disclosure will be described while referring to the drawings. In the drawings, a structural element indicated using the same signs means the same structural element. However, unless specifically noted otherwise in the description, each structural element is not limited to a single structural element, and multiple such structural elements may be present.

Also, a description may be reduced or omitted for duplicate configurations and signs in the drawings. Note that the present disclosure is not limited to the following exemplary embodiment and may be carried out with modifications applied thereto as appropriate, such as omitting a configuration, replacing a configuration with a different configuration, or using a combination of one embodiment and any of various exemplary modifications, within the scope of an objective of the present disclosure.

### <Information Processing System 100>

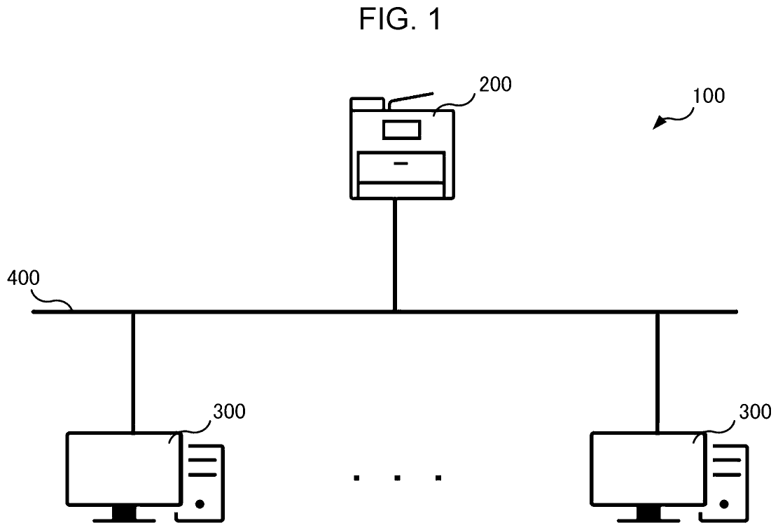

FIG. 1 is a diagram illustrating a system configuration of an information processing system 100 according to an exemplary embodiment of the present disclosure. The information processing system 100 according to the present exemplary embodiment prints onto a print medium such as roll paper, which is one example of paper. As illustrated in FIG. 1, the information processing system 100 according to the present exemplary embodiment includes a printer 200 as one example of an image forming apparatus, and multiple personal computers (PCs) 300.

The units of the information processing system 100, that is, the printer 200 and the multiple PCs 300, are interconnected by a communication channel 400. The communication channel 400 uses wired lines, wireless channels, or both, for example. Specifically, any of various types of networks, such as a local area network (LAN) or the Internet, for example, may be used as the communication channel 400. The following describes each unit of the information processing system 100.

### <PC 300>

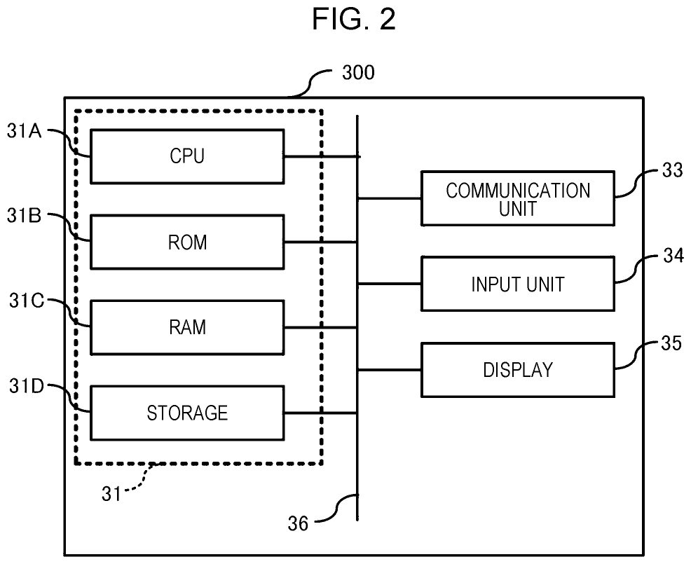

Each PC 300 in the information processing system 100 according to the present exemplary embodiment is an apparatus that transmits printed material information, which is information related to printed material, to a printer. FIG. 2 is a block diagram illustrating a hardware configuration of the PC 300 according to the exemplary embodiment.

As illustrated in FIG. 2, the PC 300 includes a control device 31, a communication unit 33, an input unit 34, and a display 35. These structural elements are interconnected through a control bus 36.

The communication unit 33 is a communication interface, and is a component for communicating with another apparatus such as the printer 200. Specifically, the communication unit 33 communicates with another apparatus through the communication channel 400 using wired lines, wireless channels, or both.

The input unit 34 is a component that accepts instructions inputted by a user. Specifically, the input unit 34 is configured as input keys (such as a keyboard and operation buttons, for example), a touch panel, and the like on which the user performs input operations, for example.

Instructions given by the user may be execution instructions causing the printer 200 to execute a job involving processes such as copy, print, scan, and facsimile processes. A job refers to a unit of processing for operations to be executed according to a single instruction from the user.

The display 35 is an example of a notification unit, and displays presentation information to be presented to the user, thereby notifying the user of the presentation information. The display 35 is configured as a liquid crystal display or an organic electroluminescence (EL) display, for example.

Note that the display 35 may also function as the input unit 34. In this case, the input unit is configured as a resistive, capacitive, or other type of touch panel, and the user inputs instructions by performing touch operations, for example.

The control device 31 controls each unit of the PC 300. The control device 31 functions as a computer, and as illustrated in FIG. 2, includes a central processing unit (CPU) 31A, read-only memory (ROM) 31B, random access memory (RAM) 31C, and storage 31D. The CPU 31A, ROM 31B, RAM 31C, and storage 31D are interconnected by the control bus 36.

The CPU 31A is a central processing unit that executes various programs, including information processing programs, and controls each unit. Note that the CPU 31A corresponds to a processor. The ROM 31B stores various programs, including information processing programs, and various data. The RAM 31C temporarily stores programs or data as a work area.

The storage 31D includes a storage medium such as a hard disk drive (HDD), a solid-state drive (SSD), or flash memory, and stores various programs, including an operating system, and various data. The various data includes data such as various settings and states of the PC 300, and printed material information to be described later. Note that information processing programs may also be stored in the storage 31D.

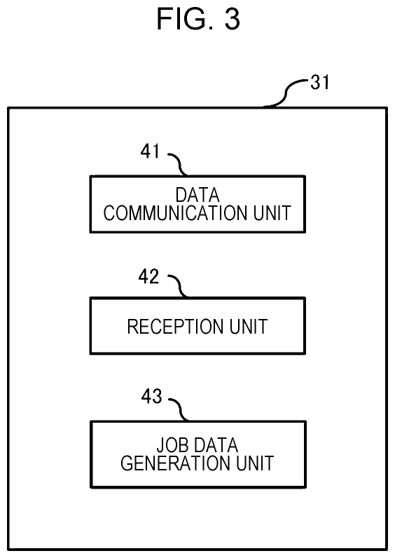

In the control device 31, the CPU 31A reads out various programs, including information processing programs, from the ROM 31B or the storage 31D, and executes the programs while using the RAM 31C as a work area. By executing the information processing programs, the CPU 31A achieves various functions for controlling each unit of the PC 300. Hereinafter, a functional configuration achieved through cooperation between the CPU 31A serving as a hardware resource and the information processing programs serving as a software resource will be described. FIG. 3 is a block diagram illustrating an example of a functional configuration of the control device 31 according to the exemplary embodiment.

In the control device 31, the CPU 31A executes an information processing program to thereby function as a data communication unit 41, a reception unit 42, and a job data generation unit 43, as illustrated in FIG. 3.

The data communication unit 41 outputs print job data to be described later to the printer 200 via the communication unit 33.

The reception unit 42 accepts a job instruction entered by the user using the input unit 34. In the present exemplary embodiment, the reception unit 42 accepts an instruction related to printing on roll paper as a job.

The job data generation unit 43 generates PDL data by executing a PDL process according to an operation by the user, for example. PDL data is data which contains printed material information and which is written in a page description language (PDL) that is interpretable by the printer 200. Note that PDL data is one example of print job data.

The PDL process converts a print object containing printed material information into the PDL data. A page description language is a computer programming language for causing image processing and the like to be executed in the printer 200. Various page description language formats exist, such as the PostScript® (PS) format.

The printed material information includes information related to a representation (image), print character data (text: a document), page information, and the like for the printed material. The print character data is data that does not include an image or the like, and includes only information indicating characters. The page information is information including the number of copies, number of pages, information about a cover sheet or the like, designated paper size information, information on the actual size of the print medium, settings information for overlay printing, page layout information, and the like.

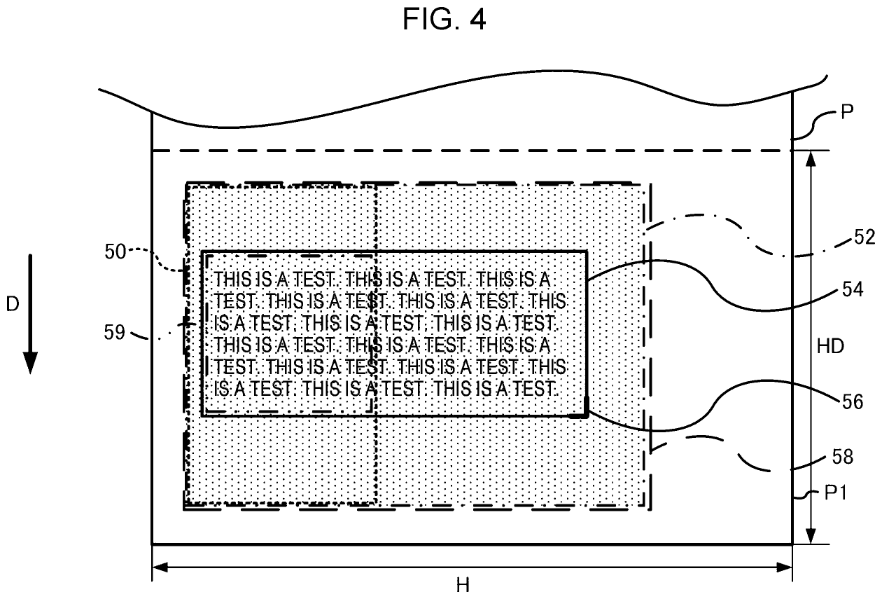

FIG. 4 is a plan view of roll paper P in overlay printing according to the present exemplary embodiment. Note that in FIG. 4, frame lines are illustrated with a slight offset from each other, but this is for the purpose of clearly illustrating the frame lines indicated by each of the signs, and the actual frame lines are overlapping. As illustrated in FIG. 4, roll paper P as one example of a print medium is printed upon by the printer 200 in the arrow D direction, that is, from top to bottom, which is the transport direction of the roll paper P, and printing is executed in the transport direction. On the roll paper P, printing is executed in each of single unit areas (single sheets of physical paper) which are preset according to the dimension of the width H orthogonal to the arrow D direction. In the present exemplary embodiment, information indicating the width H and the length HD in the arrow D direction of a single physical paper sheet P1 is actual size information about the roll paper P (print medium). Note that this actual size information may also include information indicating the size of the area indicated by width H×length HD.

The designated paper indicates the paper designated in the PDL data, and designated paper size information includes information including the dimensions in the vertical and horizontal directions of the paper designated in the PDL data and information indicating the layout position of the paper on a single physical paper sheet P1. Specifically, the designated paper size information is information indicating the size and layout position of designated paper 50 indicated by the dashed frame lines in FIG. 4.

Overlay printing is a printing method for printing a predetermined format and print character data on top of each other, and the set area of the format is referred to as the overlay area in the present exemplary embodiment. The format is a standardized form saved in advance in the storage 31D as one example, and is data indicating standardized portions of a document, such as ruled lines and headings as one example, header portions, and the like. In the present exemplary embodiment, the settings information for overlay printing includes information indicating a designated format, information indicating the layout position of the format on a single physical paper sheet P1, and the like. Specifically, the settings information for overlay printing includes information indicating a format and information indicating the size and layout position of an overlay area 52 indicated by the shading inside the chain frame lines in FIG. 4.

As one example, the page layout information includes information on an imposition designation whereby the images of multiple pages are laid out on a single page. Specifically, the information on an imposition designation is, for example, 2-up imposition information indicating that the images of two pages are to be imposed in the direction substantially orthogonal to the arrow D direction in FIG. 4, or 4-up imposition information indicating that the images of two pages are to be imposed in each of both the arrow D direction and the direction substantially orthogonal to the arrow D direction. In other words, the information on an imposition designation is information indicating the number of pages to be laid out on a single page and the layout position.

Also, the printed material information includes a print position 56 and a print area 58 of the print character data. As one example of the print position 56, the lower right corner of print character data 54 indicated by the solid frame lines in FIG. 4 is set. Also, the print area 58 is the area to be actually printed upon which is set on a single physical paper sheet P1 of the roll paper P, and is indicated as an example by the large dashed frame lines in FIG. 4.

Note that in the present exemplary embodiment, the job data generation unit 43 generates PDL data as one example of the print job data, but the present disclosure is not limited thereto, and the printed material information may also be used as the print job data.

### <Printer 200>

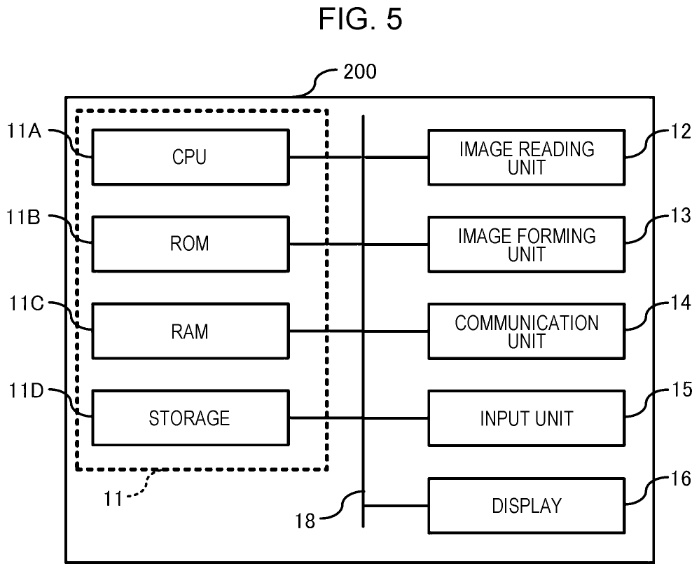

Next, the printer 200 in the information processing system 100 according to the present exemplary embodiment will be described in detail. FIG. 5 is a block diagram illustrating a hardware configuration of the printer 200 according to the present exemplary embodiment.

As illustrated in FIG. 5, the printer 200 is a device referred to as a multi-function peripheral, which includes multiple functions such as a print function, a scan function, a copy function, and a facsimile function. Specifically, as illustrated in FIG. 5, the printer 200 is provided with a control device 11, an image reading unit 12, an image forming unit 13, a communication unit 14, an input unit 15, and a display 16. These structural elements are interconnected through a control bus 18.

The image reading unit 12 is a component (for example, a scanner) that reads an image of a document. The image reading unit 12 optically reads and converts an image of a document into a digital signal, thereby generating image data. Note that an image may contain characters.

The image forming unit 13 is a component that forms an image onto the roll paper P. The image forming unit 13 forms an image onto the roll paper P according to an electrophotographic system in which the steps of charging, exposing, developing, transferring, and fusing are performed, for example. Note that the image forming unit 13 may also form an image onto a recording medium according to another system, such as an inkjet system.

The communication unit 14 is a component for communicating with other equipment such as the PC 300. Specifically, the communication unit 14 communicates with other equipment through the use of means of communication such as a wired connection, a wireless connection, the Internet, an intranet, and a public circuit such as a telephone circuit. Note that the means of communication may also be means of communication using sound or speech, light, vibration, images, and the like.

In the printer 200, a scan process by the scan function is executed by, for example, causing the image reading unit 12 to read an image of a document and generate image data. In the printer 200, a facsimile process by the facsimile function is executed by, for example, transmitting image data generated by reading an image of a document with the image reading unit 12 to another piece of equipment, such as another multi-function peripheral.

In the printer 200, a copy process by the copy function is executed by, for example, causing the image forming unit 13 to form an image onto the roll paper P on the basis of image data generated by reading an image of a document with the image reading unit 12. In the printer 200, a print process by the print function is executed by, for example, causing the image forming unit 13 to form an image onto the roll paper P on the basis of image data obtained from a terminal such as the PC 300 or smartphone, from a storage medium such as USB memory, or the like.

The input unit 15 is a component that accepts instructions inputted by the user. Specifically, the input unit 15 is configured as input keys (such as a keyboard and operation buttons, for example), a touch panel, and the like on which the user performs input operations, for example.

Instructions given by the user may be execution instructions causing the printer 200 to execute a job involving processes such as copy, print, scan, and facsimile processes.

The display 16 displays presentation information to be presented to the user. The display 16 is configured as a liquid crystal display or an organic electroluminescence (EL) display, for example. Note that the display 16 may also function as the input unit 15. In this case, the input unit is configured as a resistive, capacitive, or other type of touch panel, and the user inputs instructions by performing touch operations, for example.

The control device 11 controls each unit of the printer 200. The control device 11 functions as a computer, and as illustrated in FIG. 5, includes a central processing unit (CPU) 11A, read-only memory (ROM) 11B, random access memory (RAM) 11C, and storage 11D. The CPU 11A, ROM 11B, RAM 11C, and storage 11D are interconnected by the control bus 18.

The CPU 11A is a central processing unit that executes various programs, including information processing programs, and controls each unit. Note that the CPU 11A corresponds to a processor. The ROM 11B stores various programs, including information processing programs, and various data. The RAM 11C temporarily stores programs or data as a work area.

The storage 11D includes a storage medium such as a hard disk drive (HDD), a solid-state drive (SSD), or flash memory, and stores various programs, including an operating system, and various data. The various data includes parameters such as various settings and states of the printer 200. Note that information processing programs may also be stored in the storage 11D.

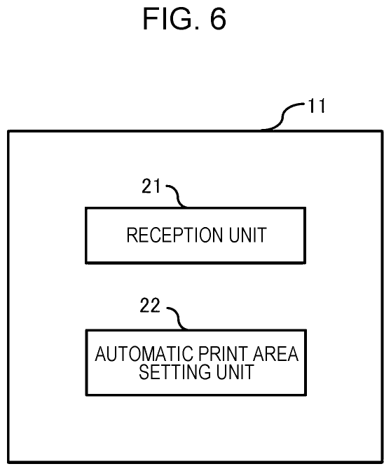

In the control device 11, the CPU 11A reads out various programs, including information processing programs, from the ROM 11B or the storage 11D, and executes the programs while using the RAM 11C as a work area. By executing the information processing programs, the CPU 11A achieves various functions for controlling each unit of the printer 200. Hereinafter, a functional configuration achieved through cooperation between the CPU 11A serving as a hardware resource and the information processing programs serving as a software resource will be described. FIG. 6 is a block diagram illustrating an example of a functional configuration of the control device 11 according to the present exemplary embodiment.

In the control device 11, the CPU 11A executes an information processing program to thereby function as a reception unit 21 and an automatic print area setting unit 22, as illustrated in FIG. 6.

The reception unit 21 accepts the print job data described above from the PC 300 via the communication unit 14. In the present exemplary embodiment, as one example, if the print job data accepted by the reception unit 21 is PDL data, the reception unit 21 generates image data (hereinafter referred to as processed data) resulting from a rendering process being executed on the PDL data.

The rendering process is an example of a conversion process, and is a process that converts PDL data to processed data. Specifically, the rendering process involves executing a bitmapping process (for example, a rasterizing process on the PDL data to convert the PDL data to image data with which image formation (printing) may be performed by the image forming unit 13.

The automatic print area setting unit 22 automatically sets the print area of the image to be formed on the roll paper P by the image forming unit 13, on the basis of the printed material information included in the print job data received by the reception unit 21. As illustrated in FIG. 4, if the print position 56 of the print character data 54 is outside the area of the designated paper 50 and printing is executed without any changes, only the print character data 54 included in the print area 59 before enlargement, which is indicated by the chain double-dot frame lines, will be printed. The result is that characters in the print character data 54 that are not included in the print area 59 before enlargement will be missing.

Accordingly, as illustrated in FIG. 4, the automatic print area setting unit 22 according to the present exemplary embodiment automatically enlarges the print area 58 in the print character data 54 so that the print position 56 of the print character data 54 is included. That is, the automatic print area setting unit 22 automatically enlarges the print area of the print character data 54 from the print area 59 before enlargement to the print area 58. Note that a method of enlarging the print area will be described in detail later.

### <Process Flow in Printer 200>

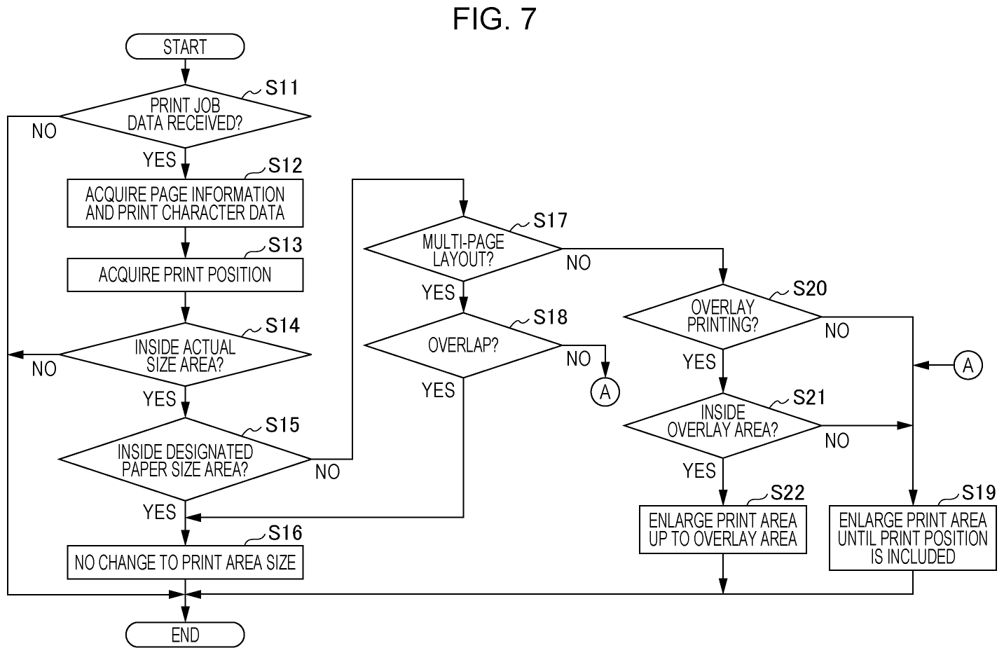

Next, the flow of a process executed in the printer 200 according to the present exemplary embodiment will be described. FIG. 7 is a flowchart illustrating an example of a process in the printer 200 according to the present exemplary embodiment. Note that the process illustrated in FIG. 7 is a process for setting the print area. This process is performed by having the CPU 11A read out an information processing program from the ROM 11B or storage 11D and execute the information processing program.

As illustrated in FIG. 7, when the printer 200 is powered on and starts to operate, the print area setting process is started. Note that in the present exemplary embodiment, as an example, the print area setting process from step S11 onward illustrated in FIG. 7 is performed at predetermined intervals until the printer 200 is powered off.

First, in step S11, the reception unit 21 determines whether or not print job data is received from the PC 300. If print job data is not received (step S11; NO), the CPU 11A ends the print area setting process. On the other hand, if print job data is received in step S11 (step S11; YES), in step S12, the automatic print area setting unit 22 acquires the page information and print character data 54 included in the printed material information from the print job data received by the reception unit 21. Specifically, as the page information, the automatic print area setting unit 22 acquires designated paper size information, information on the actual size of the print medium, settings information for overlay printing, and page layout information.

Next, in step S13, the automatic print area setting unit 22 acquires the print position 56 of the print character data 54 included in the printed material information. In step S14, the automatic print area setting unit 22 determines whether or not the print position 56 will be printed inside the area of a single physical paper sheet P1, on the basis of information on the actual size of the roll paper P. If the print position 56 will be not printed inside the area (step S14; NO), it may not be possible to print the print character data 54, and therefore the automatic print area setting unit 22 ends the print area setting process.

On the other hand, if the print position 56 will be printed inside the area (step S14; YES), in step S15, the automatic print area setting unit 22 determines whether or not the print position 56 will be printed inside the size area of the designated paper 50. Specifically, as illustrated in FIG. 4, the automatic print area setting unit 22 determines whether or not the print position 56 indicated by the lower right corner of the print character data 54 is positioned inside the dashed frame lines indicating the size area of the designated paper 50.

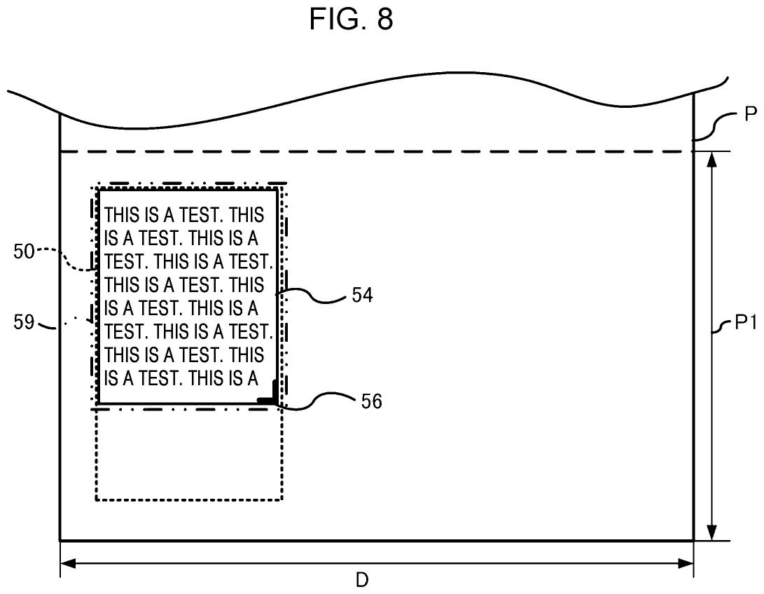

FIG. 8 is a plan view of the roll paper P in printing with no print area enlargement according to the present exemplary embodiment. In step S15, as illustrated in FIG. 8, if the print position 56 will be printed inside the size area of the designated paper 50 (step S15; YES), the print character data 54 is set inside the print area 59 before enlargement that is set inside the size area of the designated paper 50, and thus in step S16, the automatic print area setting unit 22 sets the size of the print area with no changes, and ends the print area setting process.

On the other hand, in step S15, if the print position 56 will not be printed inside the size area of the designated paper 50 (step S15; NO), in step S17, the automatic print area setting unit 22 determines whether or not to lay out multiple pages. Specifically, the automatic print area setting unit 22 determines whether or not information on an imposition designation is included in the page layout information. In step S17, if multiple pages are laid out (step S17; YES), in step S18, the automatic print area setting unit 22 determines whether or not the expanding the print area of the print character data 54 corresponding to a certain page (in the present exemplary embodiment, the page on the left side; first page) would create an overlap with another page (in the present exemplary embodiment, the page on the right side; second page) area adjacent to the certain page.

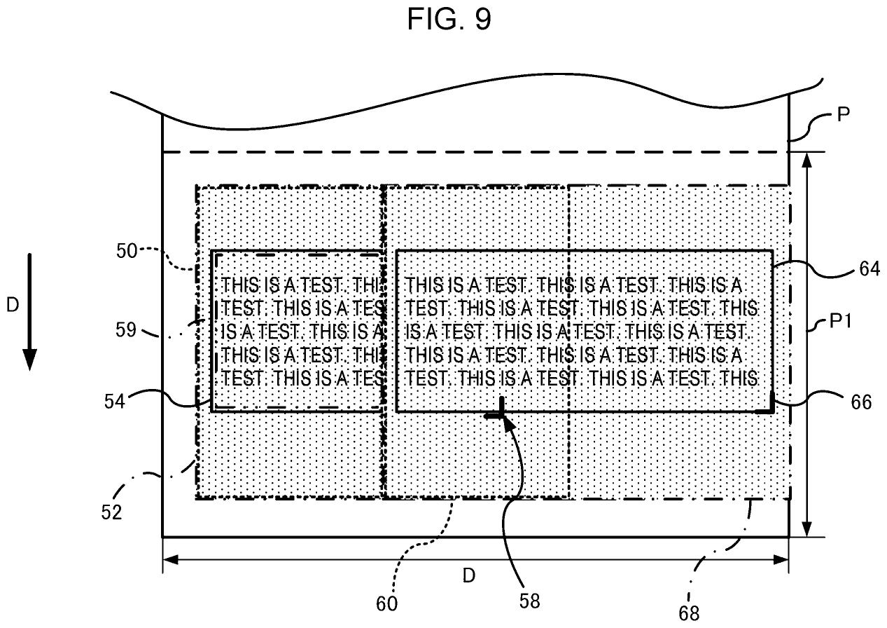

FIG. 9 is a plan view of the roll paper P in imposition printing with no print area enlargement according to the present exemplary embodiment. Specifically, suppose that imposition is specified such that the images of two pages are to be imposed in the direction substantially orthogonal to the arrow D direction, as illustrated in FIG. 9. That is, the imposition designation is set such that the first page is to be printed on designated paper 50 on the left side and the second page is to be printed on designated paper 60 on the right side. In FIG. 9, the print position 56 of the print character data 54 for the first page is positioned inside the size area of the designated paper 60. Accordingly, enlarging the print area of the print character data 54 for the first page would create an overlap with the size area of the designated paper 60, which is the page area of the second page.

In step S18, if an overlap would be created (step S18; YES), in step S16, the automatic print area setting unit 22 sets the size of the print area on the first page with no changes in order to preserve the print area 59 before enlargement of the print character data 54 for the first page, and ends the print area setting process. Note that, as illustrated in FIG. 9, an overlay area 52 to be described later may also be included in the designated paper 50 for the first page.

Also, in the present exemplary embodiment, as illustrated for example in FIG. 9, a print area 68 of print character data 64 for the second page is enlarged such that a print position 66 of the print character data 64 is included.

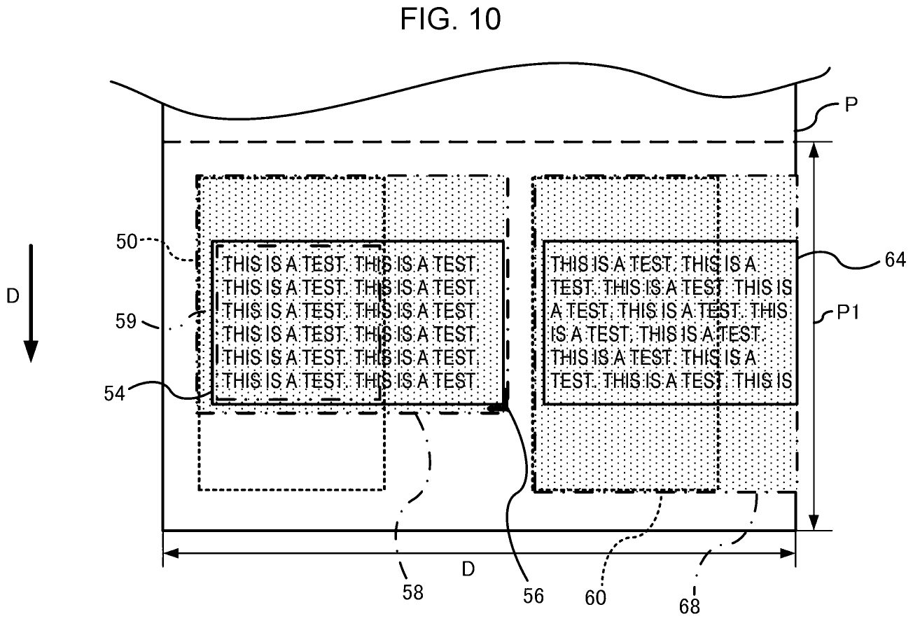

On the other hand, in step S18, if an overlap would not be created (step S18; NO), in step S19, the automatic print area setting unit 22 sets an enlarged print area of the print character data 54 for the first page, and ends the print area setting process. FIG. 10 is a plan view of the roll paper P in imposition printing with print area enlargement according to the present exemplary embodiment. Specifically, as illustrated in FIG. 10, the print position 56 of the print character data 54 for the first page is positioned outside the size area of the designated paper 60. Accordingly, an enlarged print area 58 of the print character data 54 for the first page is set such that the print position 56 of the print character data 54 is included. Note that, as illustrated in FIG. 10, an overlay area 52 to be described later may also be included in the designated paper 50 for the first page.

On the other hand, in step S17, if multiple pages are not laid out (step S17; NO), in step S20, the automatic print area setting unit 22 refers to the settings information for overlay printing and determines whether or not overlay printing is set. If overlay printing is set (step S20; YES), in step S21, the automatic print area setting unit 22 determines whether or not the print position 56 is positioned inside the overlay area 52. Specifically, as illustrated in FIG. 4, the automatic print area setting unit 22 determines whether or not the print position 56 indicated by the lower right corner of the print character data 54 is positioned inside the shaded area inside the chain frame lines indicating the overlay area 52.

In step S21, as illustrated in FIG. 4, if the print position 56 is positioned inside the overlay area 52 (step S21; YES), the print character data 54 exists inside the overlay area 52, and therefore in step S22, the automatic print area setting unit 22 sets the print area 58 enlarged up to the overlay area 52, and ends the print area setting process.

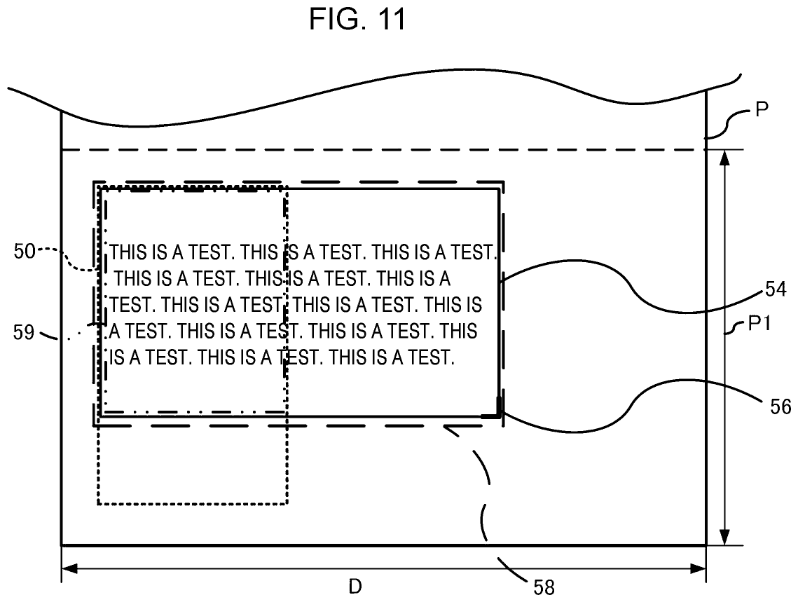

On the other hand, in step S20, if overlay printing is not set (step S20; NO), in step S19, the automatic print area setting unit 22 enlarges the print area 58 until the print position 56 is included. FIG. 11 is a plan view of the roll paper P in printing with print area enlargement that is not overlay printing according to an exemplary embodiment. In step S20, if overlay printing is not set (step S20; NO), as illustrated in FIG. 11, in step S19, the automatic print area setting unit 22 enlarges the print area 58 until the print position 56 is included, and ends the print area setting process.

Note that whether the print area enlargement process of step S19 is executed or not may also be switched according to a system setting of the printer 200 stored in advance in the storage 11D of the printer 200. In this case, if an automatic mode is set to on as the system setting, the automatic print area setting unit 22 executes the print area enlargement process of step S19. On the other hand, if the automatic mode is set to off, the automatic print area setting unit 22 sets the size of the print area with no changes, without executing the print area enlargement process of step S19, and ends the print area setting process.

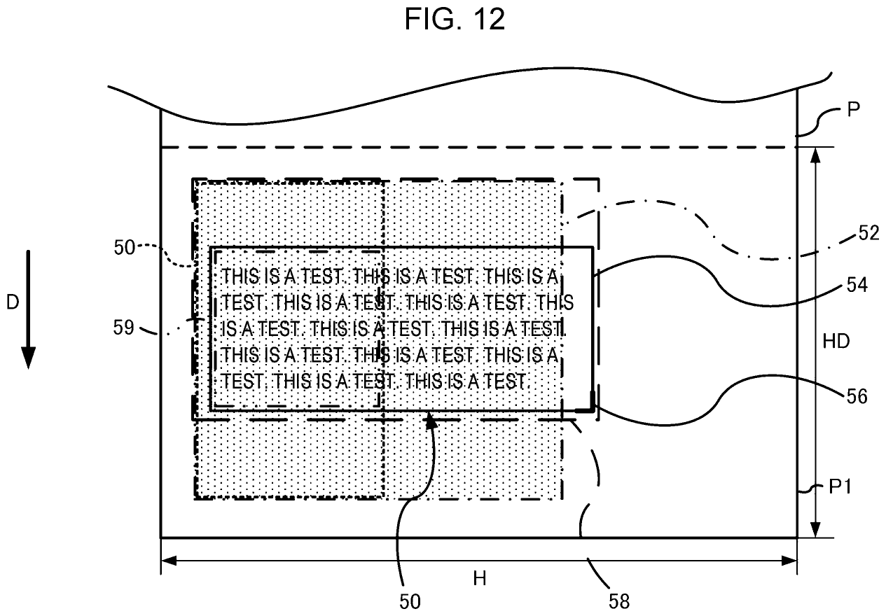

On the other hand, in step S21, if the print position 56 is not positioned inside the overlay area 52 (step S21; NO), in step S19, the automatic print area setting unit 22 enlarges the print area 58 until the print position 56 is included. FIG. 12 is a plan view of the roll paper P in printing with print area enlargement that is overlay printing according to an exemplary embodiment. In step S21, if the print position 56 is not positioned inside the overlay area 52 (step S21; NO), as illustrated in FIG. 12, in step S19, the automatic print area setting unit 22 enlarges the print area 58 until the print position 56 is included, and ends the print area setting process. Note that the print area 58 set in this way also includes a range outside the overlay area 52, as illustrated in FIG. 12.

### <Operation>

In the information processing system 100 information processing program according to the present exemplary embodiment, the CPU 11A accepts page information, including the size of the designated paper 50, and print character data 54, and if the print position 56 of the print character data 54 is outside the area of the size of the designated paper 50, the CPU 11A automatically enlarges the print area 58 in the print character data 54 such that the print position 56 is included.

Also, in the information processing system 100 according to the present exemplary embodiment, if the print position 56 of the print character data 54 is inside the overlay area 52 set in overlay printing, the CPU 11A enlarges the print area 58 up to the overlay area 52.

Also, in the information processing system 100 according to the present exemplary embodiment, the CPU 11A determines whether or not the print position 56 at the lower right corner of the print character data 54 is inside the overlay area 52.

Also, in the information processing system 100 according to the present exemplary embodiment, if the print position 56 of the print character data 54 is inside the area of a single physical paper sheet P1 of the roll paper P as the print medium, the CPU 11A sets the print area 58 inside the area of the single physical paper sheet P1.

Also, in the information processing system 100 according to the present exemplary embodiment, the CPU 11A determines whether or not the print position 56 at the lower right corner of the print character data 54 is inside the area of the single physical paper sheet P1 of the roll paper P as the print medium.

Also, in the information processing system 100 according to the present exemplary embodiment, if enlarging the print area 58 of the print character data 54 corresponding to a certain (left-side) page would create an overlap with another (right-side) page area adjacent to the certain (left-side) page, the CPU 11A preserves the print area in the print character data 54 corresponding to the certain (left-side) page.

Also, in the information processing system 100 according to the present exemplary embodiment, the CPU 11A enlarges the print area 68 in the print character data 64 corresponding to the other (right-side page).

### Other Exemplary Embodiments

The foregoing describes the information processing system 100 according to one exemplary embodiment of the present disclosure, but the technology of the present disclosure is not limited to the exemplary embodiment above, and modifications may also be made, as appropriate.

Also, in the exemplary embodiment above, a multi-function peripheral (specifically, the printer 200) is used as an example of an image forming apparatus, but the configuration is not limited thereto. The equipment may also be, for example, an apparatus such as a printer that only executes print processes, and an image forming apparatus other than a multi-function peripheral may also be used. The example of a terminal that outputs a print instruction to the printer 200 is not limited to the PC 300 and may also be a terminal such as a smartphone, or any device capable of communication.

Also, in the exemplary embodiment above, the “process to determine whether or not the print position 56 will be printed inside the area of the single physical paper sheet P1” indicated in step S14 of FIG. 7 is performed between the processes in steps S13 and S15, but the timing of the process in step S14 is not limited thereto. This process may be performed at any timing before the “process to enlarge the print area” indicated in step S19 of FIG. 7.

Also, in the exemplary embodiment above, the printer 200 is assumed to be an apparatus that prints onto the roll paper P, which is continuous paper, but the printer 200 may also be an apparatus that prints onto cut paper without being limited to the roll paper P.

Also, in the exemplary embodiment above, a form is described in which the CPU 11A of the printer 200 performs the print area setting process, but the print area setting process need not be performed by the CPU 11A of the printer 200. For example, if the information processing system 100 includes a server (not illustrated) that may be interconnected with the printer 200 and the PC 300, a CPU installed in the server may perform the print area setting process. In this case, data indicating a print area setting process result is outputted from the server to the printer 200.

In the exemplary embodiment above, the term “processor” refers to hardware in a broad sense. Examples of the processor include general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

Also, a program realizing an exemplary embodiment of the present disclosure obviously may be provided via a communication medium, and may also be provided by being stored on a recording medium such as CD-ROM.

The present disclosure is not limited to the exemplary embodiment above, and various modifications, alterations, and improvements are possible without deviating from the gist of the present disclosure. For example, the exemplary modifications indicated above may also be plurally combined, as appropriate.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system including at least one processor configured to accept page information, including a size of designated paper, and print character data, and if a print position of the print character data is outside an area of the size of the designated paper, automatically enlarge the print area in the print character data such that the print position is included.

(((2)))

The information processing system according to (((1))), wherein:
the page information includes settings information for overlay printing, and
if a print position of the print character data is inside an overlay area set in overlay printing, the processor is configured to enlarge the print area up to the overlay area.
   (((3)))

The information processing system according to (((2))), wherein the processor is configured to determine whether or not the print position at a lower right corner of the print character data is inside the overlay area.

(((4)))

The information processing system according to any one of (((1))) to (((3))), wherein:
the page information includes information on an actual size of a print medium, and
if a print position of the print character data is inside the area of the print medium, the processor is configured to enlarge the print area inside the area of the print medium.
   (((5)))

The information processing system according to (((4))), wherein the processor is configured to determine whether or not the print position at a lower right corner of the print character data is inside the area of the print medium.

(((6)))

The information processing system according to any one of (((1))) to (((5))), wherein:
the page information includes layout information in which a plurality of pages are laid out on a print medium, and
if enlarging the print area of the print character data corresponding to a certain page would create an overlap with another page area adjacent to the certain page, the processor is configured to preserve the print area in the print character data corresponding to the certain page.
   (((7)))

The information processing system according to (((6))), wherein the processor is configured to enlarge the print area in the print character data corresponding to the other page.

(((8)))

An information processing program causing a computer to execute a process comprising:
accepting page information, including a size of designated paper, and print character data; and
if a print position of the print character data is outside an area of the size of the designated paper, automatically enlarging the print area in the print character data such that the print position is included.

What is claimed is:

1. An information processing system comprising:
at least one processor configured to:
accept page information, including a size of designated paper, and print character data; and
if a print position of the print character data is outside an area of the size of the designated paper, automatically enlarge the print area in the print character data such that the print position is included.

2. The information processing system according to claim 1, wherein:
the page information includes settings information for overlay printing, and
if a print position of the print character data is inside an overlay area set in overlay printing, the processor is configured to enlarge the print area up to the overlay area.

3. The information processing system according to claim 2, wherein the processor is configured to determine whether or not the print position at a lower right corner of the print character data is inside the overlay area.

4. The information processing system according to claim 1, wherein:
the page information includes information on an actual size of a print medium, and
if a print position of the print character data is inside the area of the print medium, the processor is configured to enlarge the print area inside the area of the print medium.

5. The information processing system according to claim 4, wherein the processor is configured to determine whether or not the print position at a lower right corner of the print character data is inside the area of the print medium.

6. The information processing system according to claim 1, wherein:
the page information includes layout information in which a plurality of pages are laid out on a print medium, and
if enlarging the print area of the print character data corresponding to a certain page would create an overlap with another page area adjacent to the certain page, the processor is configured to preserve the print area in the print character data corresponding to the certain page.

7. The information processing system according to claim 6, wherein the processor is configured to enlarge the print area in the print character data corresponding to the other page.

8. An information processing method comprising:
accepting page information, including a size of designated paper, and print character data; and
if a print position of the print character data is outside an area of the size of the designated paper, automatically enlarging the print area in the print character data such that the print position is included.

9. A non-transitory computer readable medium storing a program causing a computer to execute a process comprising:
accepting page information, including a size of designated paper, and print character data; and
if a print position of the print character data is outside an area of the size of the designated paper, automatically enlarging the print area in the print character data such that the print position is included.
